(19) United States
(12) Patent Application Publication
(10) Pub. No.: US 2008/0047881 A1
(43) Pub. Date: Feb. 28, 2008

(54) Automatic Brine Tank Level Sensor Incorporating a Capacitive Oscillator

(76) Inventors: (Andy) Andrew Fredrick Buck, Everton (CA); Arnold Wayne Carney, Auburn, PA (US)

Correspondence Address: A. WAYNE CARNEY, 2625 WYNONAH DRIVE, ARBUM, PA, 17922-9404, US

(21) Appl. No.: 11/846,120

(22) Filed: Aug. 28, 2007

Related U.S. Application Data
(60) Provisional application No. 60/847,888, filed on Sep. 29, 2006.

(51) Int. Cl. C02F 1/00

(52) U.S. Cl. 210/85; 210/739; 210/96.1; 210/97; 210/143

(57) ABSTRACT

The present invention automatically detects whether the level of salt in a water softener brine tank is above an acceptable level. If the sensor determines that the level is not acceptable it will notify the user. The salt level sensor is mounted on the exterior of the brine tank, and continually detects the level of the salt in the brine tank through the wall of the brine tank. The brine tank level sensor comprises an enclosure containing a single sensing plate connected to a capacitive sensitive oscillator. The oscillator circuit is connected to the single capacitive plate which acts as the positive capacitor plate. This plate is electrically separated from the contents of the brine tank by the brine tank wall itself. The opposing brine inside the brine tank adjacent the sensing plate acts as the second capacitor plate which completes the capacitor circuit. As the brine level in the tank is altered due to regeneration, this affects the capacitance of the sensing plate, altering the frequency of the oscillator. A microprocessor senses the change in frequency which may then update the user interface. The user interface could be but is not limited to: LED's to display levels such as high, medium, and low; a wireless communication link to a remote indicator; an audible alarm; a telephone or internet connection.

### CROSS-REFERENCE TO RELATED APPLICATIONS

US patent Documents

US007239 B1 7/2007 Maxwell et al.

US006696 B2 2/2004 Bearak

US005346 A 9/1994 Christner et al.

US005239 A 8/1993 Rak

US004987 A 1/1991 Jackson

US004917 A 4/1990 Fettes et al.

### STATEMENT REGARDING FEDERALLY SPONSORED RESEARCH OR DEVELOPMENT

Not Applicable

### BACKGROUND OF THE INVENTION

This invention relates to an external tank mounted salt sensor that is physically separated from the salt. More specifically it relates to an automatic tank mounted salt sensor that is physically separated from the salt by the tank wall but still detects and indicates when the level of salt is becoming low and insufficient to completely regenerate the resin in subsequent regenerations.

Water softeners are used in residential, commercial and industrial applications to remove calcium and magnesium in exchange for sodium to soften water. Residential and commercial water softeners, by softening water, prevent scale buildup in pipes and appliances, as well as improving performance of dish wash and laundry detergents, and shampoos. Industrial water softeners, by softening water, also provide benefits for many process applications.

In the process of treating hard water, the ion exchange resin in the water softener exchanges sodium ions for calcium and magnesium ions in the water. As the resin is being depleted of sodium ions and replaced with calcium and magnesium ions, the softener must be regenerated with a salt solution. Water softening is then suspended while the softener goes through a salt regeneration cycle. The regeneration cycle is typically multi-step and is dependent on the manufacturers engineering design of the softener. This regeneration cycle typically is programmed to occur during a low water demand period for the user. As the unit regenerates, it pulls salt solution from the salt tank, which can be either a separate tank from the ion exchange resin tank, or both tanks can be incorporated into one appliance unit. Over time, the salt level drops in the salt tank from the water softener regeneration cycles.

In most water softener units the salt level must be manually checked by the user, and salt added, as needed, to assure the user does not run out of soft water. Prior art to monitor salt levels in a water softener have included an indicator stick with reference marks inside the tank; electronic monitors designed to utilize a weighted sensor on top of the salt to determine the salt level; a sensor utilizing a brine float; and a monitor that includes a signal emitter with signal detecting sensors placed vertically inside the brine tank. These salt level monitors for water softeners have not met the requirements of the water softener user, specifically because of the cost of a sub audible sensor mounted in the lid of a tank, or the modifications required to install a weight sensor for a monitor, or the limited lifespan of equipment when installed inside the salt tank due to deterioration caused by the corrosive salt environment. In addition, previous salt monitors would not be suitable for installation on water softeners already manufactured and placed in use.

### BRIEF SUMMARY OF THE INVENTION

It is therefore an object of this invention to provide an improved salt sensor for salt level notification that can be easily installed on after market water softeners, or by original equipment manufacturers placing the sensor either embedded into the wall of the salt tank during manufacture of the water softener, or as an external mounted unit.

It is another object of this invention to provide a novel method for sensing metallic salt level through a tank wall. It is expected that metallic salts such as sodium chloride, potassium chloride, magnesium chloride, calcium chloride, as examples, can be detected and measured by this technology.

It is another object of this invention to provide long life and reliability for the sensor since it is insulated from the corrosive salt environment inside the salt tank.

It is another object of this invention for the salt sensor to transmit a wireless signal to a remote receiver containing either a light emitting diode (LED) light or alarm so the user knows when salt needs to be added to the tank without manually having to check the tank.

### BRIEF DESCRIPTION OF THE DRAWINGS

FIG. 1 is a view of a water softener salt tank with the salt level sensor attached. It also shows the power plug attached. The lid of the salt tank is not shown.

FIG. 2 shows the charge difference between a sufficient and an insufficient salt condition. It is shown as a side view with the near side not shown for clarity.

FIG. 3 shows the electric field which occurs between the sensor plate and the salt in the brine tank. It is shown as a side view with the near side not shown for clarity.

FIG. 4 is a simplified block diagram of the sensor.

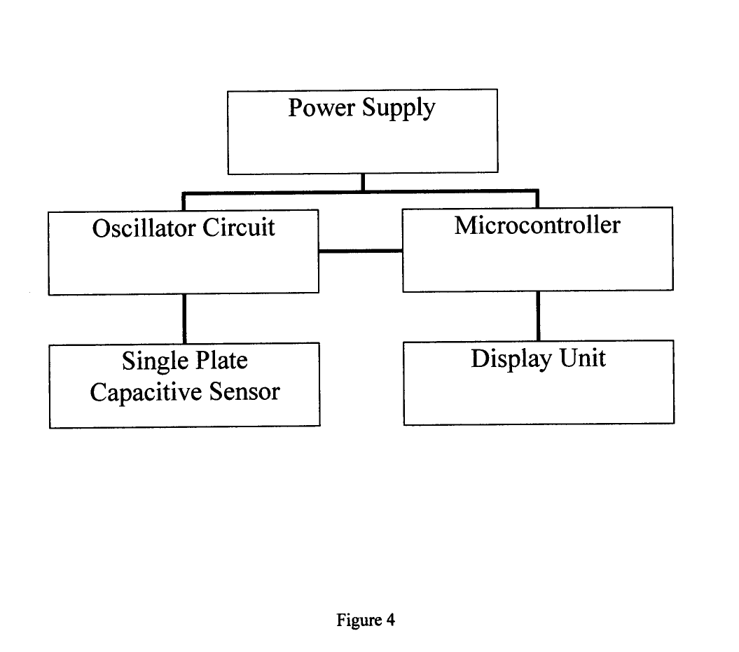

FIG. 5 is a detailed drawing of the salt sensor showing a sensor casing 18 attached to a salt tank wall 16 by a piece of two sided adhesive tape 17. Inside the sensor casing 18 a sensing plate 19 is attached to a printed circuit board 20 by the mounting hardware 22. The sensing plate 19 is electrically connected to the printed circuit board 20 by a single electrical connection 21. The status of the salt sensor is displayed on light emitting diodes (LED's) 23. The LED's can either be mounted at the sensor, or a signal can be transmitted to a receiver containing LED's at a remote location within range of a radio transmitter. The entire sensor is powered by a power supply 4 connected via a power cord 6 to a power connector 24.

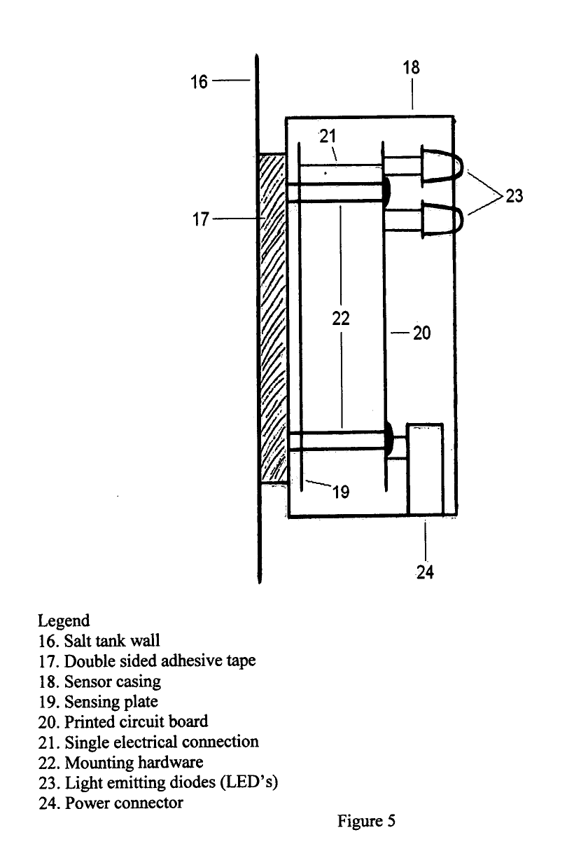

### DETAILED DESCRIPTION OF THE INVENTION

The brine tank level sensor comprises an enclosure containing a single sensing plate connected to a capacitive sensitive oscillator. The oscillator circuit is connected to the single capacitive plate which acts as the positive capacitor plate. This plate is electrically separated from the contents of the brine tank by the brine tank wall itself. The opposing brine inside the brine tank adjacent the sensing plate acts as the second capacitor plate which completes the capacitor circuit. As the brine level in the tank is altered due to regeneration, this affects the capacitance of the sensing plate, altering the frequency of the oscillator. A microprocessor senses the change in frequency which may then update the user interface. The user interface could be but is not limited to; LED's to display levels such as high, medium, and low; a wireless communication link to a remote indicator; an audible alarm; a telephone or internet connection.

The present invention automatically detects whether the level of salt in a brine tank is above an acceptable level. If the sensor determines that the level is not acceptable it will notify the user.

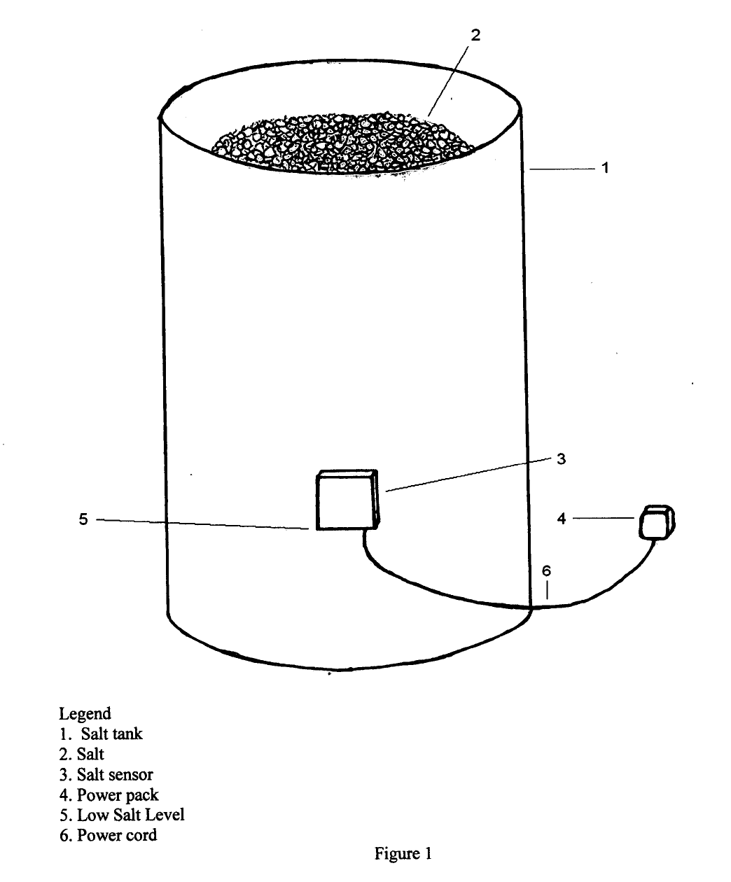

The salt level sensor is mounted on the exterior of the brine tank. The sensor will detect the level of the salt in the brine tank through the wall of the brine tank. The level of the salt in the tank is determined to be above or below a certain point on the tank, which is based on where the sensor is mounted vertically on the brine tank as shown in FIG. 1.

The operation of the sensor requires no input from an operator. The operator is notified via a display unit, which can be either directly connected to, or wirelessly communicated to, by the sensor unit. The display unit will automatically turn on an indicator, LED or alarm, in the event of a low salt condition at the sensor.

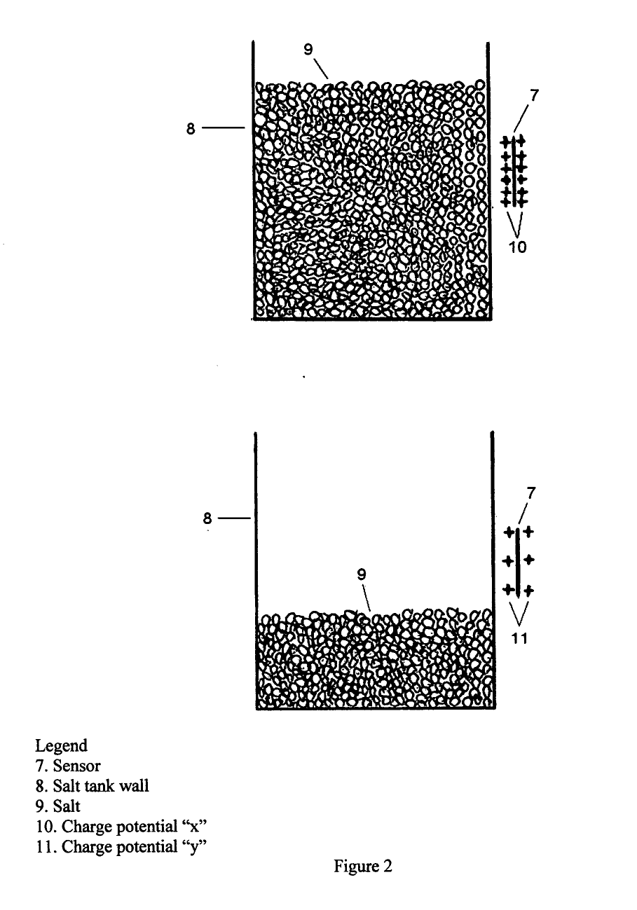

The sensor is made of a single copper plate, which has one electrical connection to a circuit. The circuit uses an operational amplifier to create an oscillator. The oscillator's output frequency is based on the capacitance of the single copper plate. The capacitance of the single plate capacitor varies as the medium in the brine tank changes. When there is salt opposite the sensor plate, the sensor (capacitor) will have a certain charge potential, as shown in FIG. 2. When there is no salt opposite the sensor it will have a different charge potential, as shown in FIG. 2. The level of salt relative to the sensor will vary the charge potential of the sensor proportionally. This is what allows the sensor to differentiate between the conditions where there is a sufficient amount of salt and when there is an insufficient amount of salt.

Any microcontroller can be used to measure the frequency of the oscillator's output. Many types of oscillators can be used to output a frequency based on the single plate capacitor's capacitance. The single plate used for the sensor can be made of many types of conductors and is not limited to just copper, and could be made of any another conducting material. The microcontroller could also be used to interpret the sensor's output frequency in other ways. This could include measuring the period to determine when the salt is approaching a low condition, such as having multiple levels of warnings.

Other possibilities include having two or more sensor plates at different levels on a brine tank. The output signals from each sensor could be interpreted by a single unit to determine more accurately the level of the salt. Such possibilities provide more accuracy and levels, whereas the single sensor provides a more economical approach.

Capacitance is defined as the amount of charge the capacitor can hold, divided by the voltage which is applied.
C=Q/V
Where:
C=Capacitance
Q=Charge
V=Voltage (constant)

The main factors affecting capacitance are the area of the plates, the spacing between the plates, and the dielectric (the substance between the plates). This sensor uses a constant area for the sensing plate. The second plate is virtual and the capacitance is measured between the positively charged (sensing) plate and a virtual ground. The virtual ground is in this case the salt in the brine tank. The salt near the sensor plate becomes negatively charged as shown in FIG. 2. The dielectric is air. The factor which is being affected is therefore the spacing of the plates (one being the sensor and the other being the virtual plate, the salt). As the level of salt in the tank changes (typically will slowly be lowered) as will the relative permittivity. Permittivity is the measure of a materials ability to establish electric flux¹.
¹ Robbins et al, Circuit Analysis, Theory and Practice. Page 388

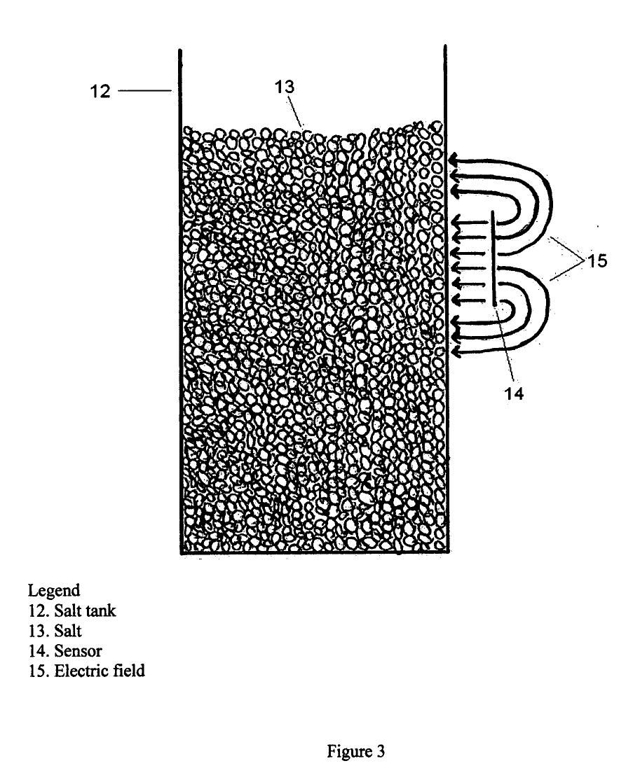

The amount of charge which can be stored by the capacitor is increased as the plates are moved closer to one another. This is because of the nature of a capacitor. As the two plates become closer together there are more electrons (negatively charged) drawn towards the positively charged plate. A capacitors capacitance is inversely proportional to the spacing of its plates. This means that the capacitance of the sensor is increased as the salt becomes closer to the sensor plate. As more salt is present opposite the sensor, the electric field as shown in FIG. 3 will become denser. When the salt tank is filled with salt to or above the sensor level, the capacitance is high, relative to when the salt level is below the sensor level. This allows the circuit of the sensor to determine when the salt is below an acceptable level. The capacitance is used to create an oscillator which outputs a frequency which input into a microcontroller. The microcontroller can then measure the frequency, which is directly proportional to the capacitance of the sensor, and determine the low salt condition.

The microcontroller can then use this information to trigger communication with the display unit to notify the user that there is an unacceptable level of salt in the tank. Once the user is notified of the low salt condition they can arrange to have the salt tank refilled. The sensor will effectively notify the user to add salt thus preventing the occurrence of the water softener not being able to regenerate due to a lack of salt.

Once the salt level in the salt tank is replenished, the sensor detects this change. The rising level of the salt (or filled event) will create a high amount of charge between the sensor plate and the salt. The sensor's capacitance will then return to the condition indicating the salt is at an acceptable level. The sensor can then communicate with the display unit, to have it automatically reset itself. No user intervention is required in order for this reset to occur. The low salt condition will be displayed until the brine tank is filled to a level above where the sensor is positioned on the tank.

At this point, the sensor has been tested and shown effective for sodium chloride and potassium chloride, and would be expected to work equally well on any metallic salt.

The sensor does not reside inside the salt tank where the conditions are harsh and not very suitable for electronic components. This allows for longer life and reliable operation. The sensor does not require any modifications to existing tanks in order to be installed. The installation of the sensor is very simple and does not require the user to remove any salt from the tank or calibrate any components. The sensor can work on any size or shape of tank as opposed to detectors designed specifically for the lid (ultrasonic), or floor (weight sensor) of a tank. This makes the sensor more suitable to a wider range of applications than prior art.

1) to provide a sensor which resides external to the salt tank, and can be attached to new or already installed salt tanks

2) to provide a sensor which will work with any metallic salt (e.g. sodium or potassium chloride for water softening).

3) to provide a sensor which involves no adjustments from a user after installation.

4) to provide a salt sensor that will transmit a wireless signal to a remote receiver containing either a light emitting diode (LED) light or alarm so the user knows when salt needs to be added to the tank without manually having to check the tank.
